(19) United States
(12) Patent Application Publication
(10) Pub. No.: US 2022/0039212 A1
(43) Pub. Date: Feb. 3, 2022

(54) CERAMIC HEATER FOR INDEPENDENTLY CONTROLLING MIDDLE REGION

(71) Applicant: MICO CERAMICS LTD., Anseong (KR)

(72) Inventor: Chul Ho JUNG, Pyeongtaek (KR)

(21) Appl. No.: 17/277,191

(22) PCT Filed: Sep. 5, 2019
(86) PCT No.: PCT/KR2019/011447

§ 371 Date: Mar. 17, 2021

(30) Foreign Application Priority Data
Oct. 16, 2018 (KR) 10-2018-0123228

(51) Int. Cl. H05B 3/28; H05B 3/74; H05B 3/03

(52) U.S. Cl. CPC H05B 3/283; H05B 2203/002; H05B 3/03; H05B 3/74

(57) ABSTRACT

The present invention relates to a ceramic heater for independently controlling a middle region, and more specifically, to a ceramic heater comprising: a center-edge heating element provided at a position corresponding to a center region and an edge region of a heating surface of the ceramic heater; and a middle heating element provided at a position corresponding to a middle region which is surrounded by the center region and the edge region of the heating surface of the ceramic heater, and thus the present invention has an effect whereby the respective temperatures of three divided regions may be

### CROSS-REFERENCE TO RELATED APPLICATIONS

This application is a National Phase Entry Application of PCT Application No. PCT/KR2019/011447 filed on 5 Sep. 2019, which claims priority to Korean Patent Application No. 10-2018-0123228 filed on 16 Oct. 2018 in Korean Intellectual Property Office, the entire contents of which is hereby incorporated by reference in its entirety.

### BACKGROUND OF THE INVENTION

### Field of the Invention

The present disclosure relates to a ceramic heater having an independently controllable middle region and, more specifically, to a ceramic heater configured such that, in order to variously implement the temperature distribution of a heating surface of the ceramic heater, the middle region of the heating surface, other than the center region and edge region thereof, can be independently controlled.

### Background of the Invention

Ceramic heaters are used for heat treatment of objects for various purposes, such as semiconductor wafers, glass substrates, and flexible substrates, at predetermined heating temperatures. In general, a ceramic heater includes a ceramic plate configured to receive power supplied from an external electrode and to generate heat thereby, and the ceramic plate includes a heating element having a predetermined resistance, embedded in the ceramic plate. The temperature distribution of the heating surface of the ceramic heater can be adjusted through arrangement and design of the embedded heating element. Specifically, the temperature of the heating surface of the ceramic heater can be variously changed by changing the interval, shape, material, thickness, or the like of the heating element.

The temperature distribution formed on the heating surface of the ceramic heater may be variously demanded according to the characteristics of the object to be heated. If a single heating element is alone used to design a ceramic heater, the embedding interval, the embedding interval, the material, the thickness, or the like of the heating element embedded in the ceramic heater may be changed. However, there is a problem in that, since the ceramic plate of the ceramic heater has a high degree of thermal conductivity, it is difficult to evenly implement various temperature distributions, which are demanded as described above, in respective regions.

Accordingly, two or more independent heating elements may be embedded in a ceramic heater. If a large number of independent ceramic heaters are embedded in a ceramic heater, the number of electrodes for supplying power to the heating elements increases accordingly. In addition, control equipment for supplying power to each heating element increases in proportion to the number of heating elements, thereby resulting in a substantial cost increase. Furthermore, if a large number of electrodes are arranged to supply power to a large number of heating elements in a limited space, there is an increasing possibility that a short circuit may occur between respective electrodes inside the ceramic heater or between respective power supply lines inside the ceramic heater.

### BRIEF SUMMARY OF THE INVENTION

It is an aspect of the present disclosure to provide a ceramic heater having an independently controllable middle region such that the temperature change of the heating surface of the ceramic heater can be variously implemented.

It is another aspect of the present disclosure to provide a ceramic heater having an independently controllable middle region configured such that temperatures of three regions of the heating surface of the ceramic heater are controlled by two power supply devices.

In accordance with an aspect of the present disclosure, there is provided a ceramic heater 100 having an independently controllable middle region, the ceramic heater including: a center-edge heating element 200 provided at a position corresponding to a center region and an edge region of a heating surface of the ceramic heater; and a middle heating element 300 provided at a position corresponding to a middle region surrounded by the center region and the edge region of the heating surface of the ceramic heater. Herein, the middle heating element 300 may be formed to have a ring shape

In addition, in accordance with an aspect of the present disclosure, the center-edge heating element 200 and the middle heating element 300 may be electrically separated to be driven independently of each other.

In addition, in accordance with an aspect of the present disclosure, the center-edge heating element 200 and the middle heating element 300 may be embedded in the ceramic heater.

In addition, in accordance with an aspect of the present disclosure, the center-edge heating element 200 and the middle heating element 300 may be provided on the same plane.

In addition, in accordance with an aspect of the present disclosure, the center-edge heating element 200 and the middle heating element 300 may be provided on different planes. At least one portion of the center-edge heating element 200 and the middle heating element 300 may be disposed to overlap each other in a vertical direction.

In addition, in accordance with an aspect of the present disclosure, the center-edge heating element 200 may include a center heating element 210 and an edge heating element 220 that are provided on different planes.

In addition, in accordance with an aspect of the present disclosure, the center-edge heating element 200 and the middle heating element 300 may be resistance heating elements. Materials of the resistance heating elements may be molybdenum (Mo).

In addition, in accordance with an aspect of the present disclosure, the center-edge heating element 200 may include a center heating element disposed at a position corresponding to the center region, and an edge heating element disposed at a position corresponding to the edge region, and the center heating element and the edge heating element may be electrically connected to each other. The center heating element may have a heating wire arrangement density or a heating wire thickness different from the edge heating element.

In addition, in accordance with an aspect of the present disclosure, one of electrode terminals of the center-edge heating element 200 and one of electrode terminals of the middle heating element 300 may be configured as a common terminal.

In addition, in accordance with an aspect of the present disclosure, electrode terminals of the center-edge heating element 200 may be disposed on a plane where the center-edge heating element is provided. The electrode terminals of the middle heating element 300 may be disposed on a plane where the middle heating element is provided. The electrode terminals may be disposed on an inside of a region corresponding to a region occupied by a shaft 120 on a surface opposite to the heating surface of the ceramic heater.

### BRIEF DESCRIPTION OF THE DRAWINGS

FIG. 1 illustrates an example of a ceramic heater having an independently controllable middle region according to the present disclosure;

FIGS. 2A to 2C illustrate a combination and an arrangement of heating elements included in a ceramic heater having an independently controllable middle region according to the present disclosure;

FIGS. 3 to 7 are cross-sectional views illustrating a cross-section of a ceramic heater having an independently controllable middle region according to an embodiment of the present disclosure;

FIG. 8 illustrates a temperature type of a heating surface of a ceramic heater having an independently controllable middle region according to an embodiment of the present disclosure;

FIGS. 9A to 9C illustrate an exemplary structure of heating elements and heating element electrode terminals of a ceramic heater having an independently controllable middle region according to an embodiment of the present disclosure;

FIGS. 10A and 10B illustrate a formation position of heating element electrode terminals of a ceramic heater having an independently controllable middle region according to an embodiment of the present disclosure; and

FIG. 11 illustrates an exemplary structure in which a common terminal is applied in connection with a structure regarding heating elements and heating element electrode terminals of a ceramic heater having an independently controllable middle region according to an embodiment of the present disclosure.

### DETAILED DESCRIPTION OF THE INVENTION

Hereinafter, the present disclosure will be described in detail with reference to the accompanying drawings. Identical elements are given identical reference numerals in respective drawings. Detailed descriptions of known functions and/or features will be omitted herein. Following disclosures will be directed to parts necessary for understanding of operations according to various embodiments, and descriptions of elements that may obscure the gist of descriptions will be omitted. Some elements in the drawings may be exaggerated, omitted, or illustrated schematically. The size of each element is not entirely in accordance with the actual size, the following descriptions are not limited by relative sizes or intervals between elements in the drawings.

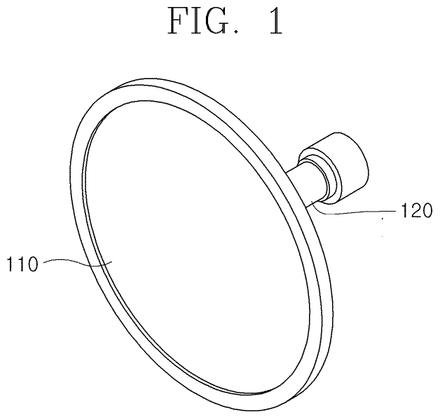

FIG. 1 illustrates an example of a ceramic heater 100 having an independently controllable middle region according to the present disclosure.

Referring to FIG. 1, the ceramic heater 100 having an independently controllable middle region includes a disk-shaped ceramic plate 110 in which a heating element is embedded, and a column-shaped shaft 120 formed on a surface opposite to a heating surface of the ceramic plate 110. The ceramic plate 110 may include the heating element embedded in the ceramic plate 110, and the shaft 120 may include a heating element rod which electrically connects a power supply device and the heating element so as to supply power to the heating element. In addition, the heating element embedded in the ceramic plate 110 may include a heating element electrode terminal electrically connected to the heating element rod.

The heating element inside the ceramic heater may receive power supplied from the power supply device through a heating element electrode and the heating element rod included in the shaft 120. The heating element supplied with power emits heat, and thermal energy emitted from the heating element is transferred to the heating surface of the ceramic plate 110, so that the thermal energy may he transferred to an object to be heated, the object being placed on the heating surface of the ceramic plate 110.

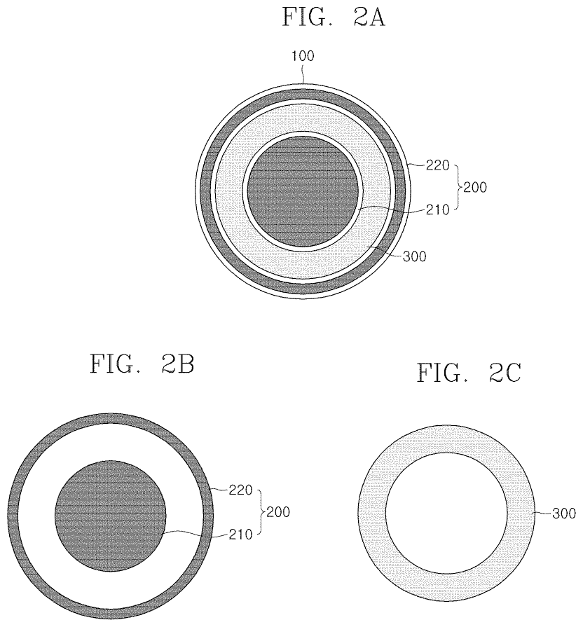

FIGS. 2A to 2C illustrate a combination and an arrangement of heating elements included in a ceramic heater 100 having an independently controllable middle region according to the present disclosure.

Referring to FIG. 2A, the ceramic heater 100 having an independently controllable middle region according to the present disclosure may include a center-edge heating element 200 and a middle heating element 300.

In more detail, the center-edge heating element may be provided at positions corresponding to a center region of a heating surface of the ceramic heater 100 having an independently controllable middle region, and an edge region of the heating surface of the ceramic heater.

Referring to FIG. 2B, in the center-edge heating element 200, a center heating element 210 may be formed at a position corresponding to a predetermined region (that is, a center region) including the center of the heating surface of the ceramic heater. The predetermined region in which the center heating element 210 is formed may be a circular region.

Referring to FIG. 2C, in the center-edge heating element 200, an edge heating element 220 may be formed at a position corresponding to a predetermined region (that is, an edge region) formed along the edge of the heating surface of the ceramic heater. The predetermined region in which the edge heating element 220 is formed may have a ring shape.

The center heating element 210 and the edge heating element 220 may be electrically connected and driven. In other words, the center heating element 210 and the edge heating element 220 may be driven by one power source.

The middle heating element 300 may be provided at a position corresponding to a middle region surrounded by the center region and the edge region of the heating surface of the ceramic heater 100 having an independently controllable middle region. The middle region where the middle heating element 300 is provided may be a region outside the center region where the center heating element 210 is provided, and a ring-shaped region corresponding to a region inside the edge region where the edge heating element 220 is provided, on the heating surface of the ceramic heater.

The center-edge heating element 200 and the middle heating element 300 may be electrically separated and independently driven. A power terminal supplied to the center-edge heating element 200 and a power terminal supplied to the middle heating element 300 may independently exist. Therefore, the power supplied to the center-edge heating element 200 and the power supplied to the middle heating element 300 may be independently controlled. Since the center-edge heating element 200 and the middle heating element 300 can be controlled by an independent power controller, the power supplied to the center-edge heating element 200 may be the same as or different from the power supplied to the middle heating element 300 according to a control manner.

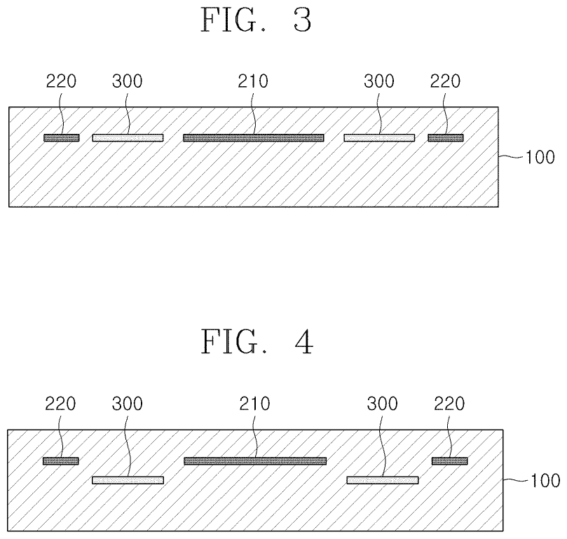

FIGS. 3 to 7 are cross-sectional views illustrating a cross-section of a ceramic heater 100 having an independently controllable middle region according to an embodiment of the present disclosure.

Referring to FIG. 3, in the ceramic heater 100 having an independently controllable middle region according to an embodiment of the present disclosure, the center-edge heating element 200 and the middle heating element 300 may be provided while being embedded, and the center-edge heating element 200 and the middle heating element 300 may be provided on the same plane.

Referring to FIG. 4, in the ceramic heater 100 having an independently controllable middle region according to an embodiment of the present disclosure, the center-edge heating element 200 and the middle heating element 300 may be provided while being embedded, and the center-edge heating element 200 and the middle heating element 300 may be provided on different planes. Accordingly, the center-edge heating element 200 may be provided on the same plane, and the middle heating element 300 may be provided on a plane different from the center-edge heating element 200.

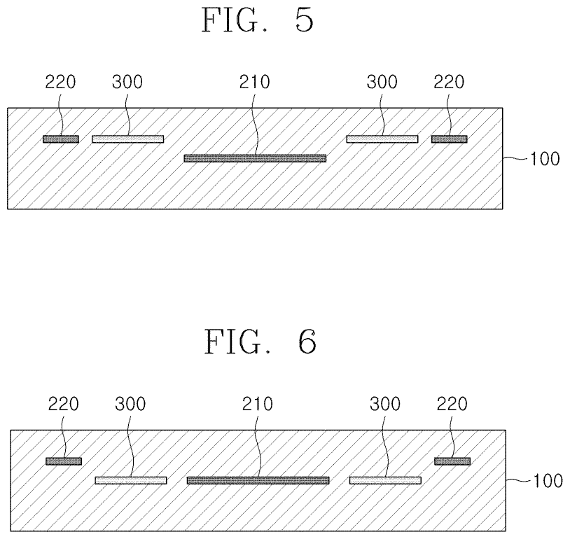

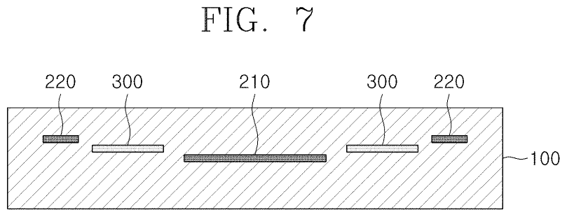

Referring to FIGS. 5 to 7, in the ceramic heater 100 having an independently controllable middle region according to an embodiment of the present disclosure, the center-edge heating element 200 and the middle heating element 300 may be provided while being embedded, and the center heating element 210 and the edge heating element 220 in the center-edge heating element 200 may be provided on different planes. Therefore, as shown in FIG. 5, the edge heating element 220 and the middle heating element 300 may be provided on the same plane and the center heating element 210 may be provided on a plane different from the edge heating element 220, and, as shown in FIG. 6, the center heating element 210 and the middle heating element 300 may be provided on the same plane and the edge heating element 220 may be provided on a plane different from the center heating element 210. Alternatively, as shown in FIG. 7, the center heating element 210, the edge heating element 220, and the middle heating element 300 may be provided on different planes, respectively.

FIGS. 5 to 7 illustrate an example in which, in the ceramic heater 100 having an independently controllable middle region according to an embodiment of the present disclosure, the center heating element 210 is provided while being embedded deeper than the edge heating element 220. However, the edge heating element 220 may be provided while being embedded deeper than the center heating element 210.

At least one portion of the center-edge heating element 200 and the middle heating element 300 of the ceramic heater 100 having an independently controllable middle region may be disposed to overlap each other in a vertical direction.

For example, as shown in FIGS. 4, 5, and 7, when the middle heating element 300 is provided on a plane different from the center heating element 210, a region heated by the middle heating element 300 and a region heated by the center heating element 210 may be designed to overlap each other on the heating surface of the ceramic heater. In other words, when the center heating element 210 has a circular shape and the middle heating element 300 has a ring shape, the radius of the center heating element 210 may be designed to be larger than the radius of the inner circumference of the middle heating element 300.

Likewise, as shown in FIGS. 4, 6, and 7, when the middle heating element 300 is provided on a plane different from the edge heating element 220, a region heated by the middle heating element 300 and a region heated by the edge heating element 220 may be designed to overlap each other on the heating surface of the ceramic heater. In other words, when the middle heating element 300 and the edge heating element 220 have a ring shape, the radius of the outer circumference of the middle heating element 300 may be designed to be larger than the radius of the inner circumference of the edge heating element 220.

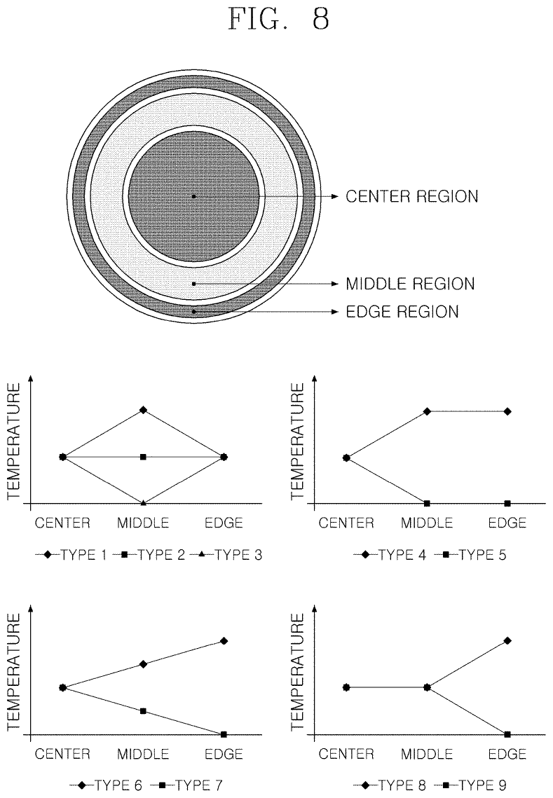

FIG. 8 illustrates a temperature type of a heating surface of a ceramic heater 100 having an independently controllable middle region according to an embodiment of the present disclosure.

Referring to FIG. 8, in relation to a temperature type of the heating surface of the ceramic heater 100 having an independently controllable middle region according to an embodiment of the present disclosure, the temperature gradient of a center region, a middle region, and an edge region can be freely implemented as desired by a designer, such as TYPE 1 to TYPE 9.

In more detail, on the heating surface of the ceramic heater 100 having an independently controllable middle region according to an embodiment of the present disclosure, the temperatures of the center region and the edge region may be designed to be implemented in various combinations. In other words, due to the diversification of the design of the center-edge heating element 200, the temperature of the center region may be implemented to be the same as the temperature of the edge region, or to be different therefrom on the heating surface of the ceramic heater. The center heating element 210 and the edge heating element 220 may receive power supplied by the same power supply device, and may be designed so that the temperatures of the center region and the edge region are the same or different from each other on the heating surface of the ceramic heater by differentiating the heating wire arrangement density of the center heating element 210 from that of the edge heating element 220, by varying the thickness of the heating wires, or by embedding heating elements in different planes as described with reference to FIGS. 4 to 7. In addition, on the heating surface of the ceramic heater, the middle heating element 300 may be driven by using an independent power source, and thus the temperature of the middle region may be implemented to be controlled independently of the temperatures of the center region and the edge region.

The center-edge heating element 200 and the middle heating element 300 may be resistance heating elements, and may be metals as resistance heating elements. More particularly, the center-edge heating element 200 and the middle heating element 300 may be molybdenum.

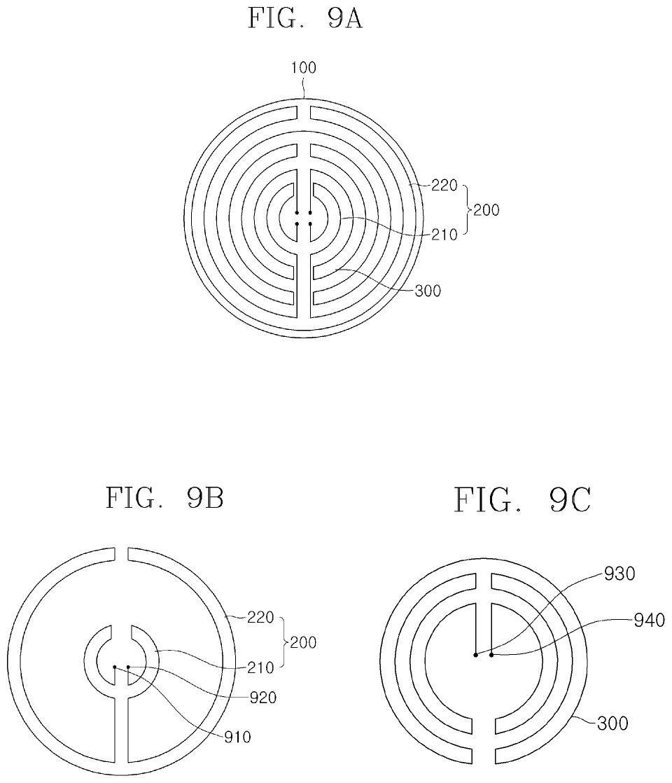

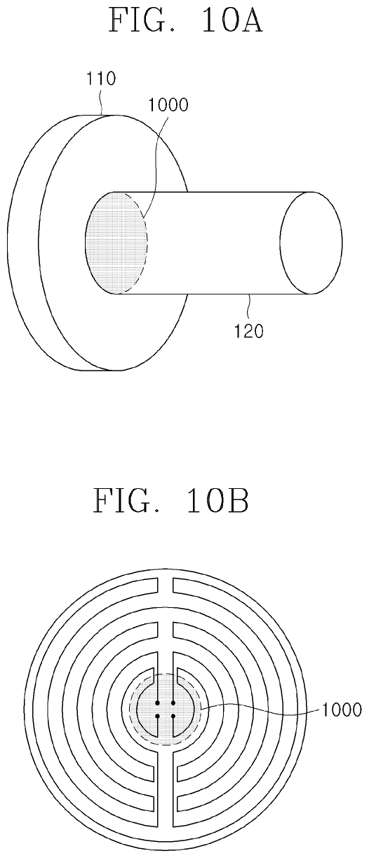

FIGS. 9A to 9C illustrate an exemplary structure of heating elements and heating element electrode terminals of a ceramic heater having an independently controllable middle region according to an embodiment of the present disclosure.

Referring to FIG. 9A, the ceramic heater 100 having an independently controllable middle region according to the present disclosure may include a center-edge heating element 200 and a middle heating element 300.

Referring to FIG. 9B, in the center-edge heating element 200, a center heating element 210 may be formed at a position corresponding to a predetermined region (that is, a center region) including the center of a heating surface of the ceramic heater. In addition, in the center-edge heating element 200, an edge heating element 220 may be formed at a position corresponding to a predetermined region (that is, an edge region) formed along the edge of the heating surface of the ceramic heater.

Referring to FIG. 9C, the middle heating element 300 may be formed at a position corresponding to a predetermined region (that is, a middle region) formed between the center region and the edge region of the heating surface of the ceramic heater.

FIGS. 10A and 10B illustrate a formation position of heating element electrode terminals of a ceramic heater having an independently controllable middle region according to an embodiment of the present disclosure.

FIG. 10A illustrates a coupling surface of a shaft 120 and a surface opposite to a heating surface of a heating element of the ceramic heater having an independently controllable middle region according to an embodiment of the present disclosure.

FIG. 10B illustrates an inside 1000 of a region corresponding to a region occupied by the shaft 120 and a shape of the heating element of the ceramic heater having an independently controllable middle region according to an embodiment of the present disclosure.

Referring to FIGS. 9A to 10B, electrode terminals 910 and 920 of the center-edge heating element 200 and electrode terminals 930 and 940 of the middle heating element 300 may be formed on the inside 1000 of a region corresponding to the region occupied by the shaft 120 on the surface opposite to the heating surface of the ceramic heater. In more detail, the center-edge heating element 200 and the middle heating element 300 included in the ceramic heater may receive power supplied from an independent power supply device through a rod of the center edge heating element 220 and a rod of the middle heating element 300, the rods being included in the shaft 120, respectively. The electrode terminals 910 and 920 of the center-edge heating element 200 and the electrode terminals 930 and 940 of the middle heating element 300, which are connection points at which the center-edge heating element 200 and the middle heating element 300 are electrically connected to the rod of the center-edge heating element 200 and the rod of the middle heating element 300, may be formed at positions corresponding to positions of the respective heating element rods included in the shaft 120 on a plane where each of the heating elements is embedded.

In other words, the electrode terminals 910 and 920 of the center-edge heating element 200 may be formed at positions corresponding to positions of rods of the center-edge heating element 200, the rods being included in the shaft 120, on a plane where the center-edge heating element 200 is embedded. Likewise, the electrode terminals 930 and 940 of the middle heating element 300 may be formed at positions corresponding to positions of rods of the middle heating element 300, the rods being included in the shaft 120, on a plane where the middle heating element 300 is embedded.

There may be two electrode terminals 910 and 920 of the center-edge heating element 200 and two electrode terminals 930 and 940 of the middle heating element 300. Accordingly, the ceramic heater 100 having an independently controllable middle region according to an embodiment of the present disclosure may include a total of four electrode terminals.

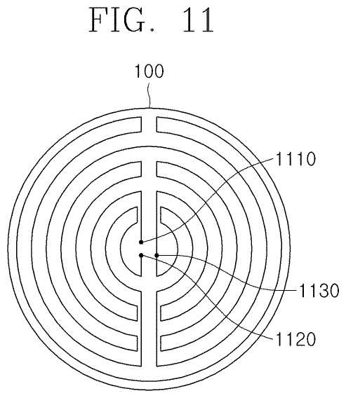

FIG. 11 illustrates an exemplary structure in which a common terminal is applied in connection with a structure regarding heating elements and heating element electrode terminals of a ceramic heater having an independently controllable middle region according to an embodiment of the present disclosure.

Referring to FIG. 11, in the ceramic heater 100 having an independently controllable middle region according to an embodiment of the present disclosure, one of two terminals configuring electrode terminals of the center-edge heating element 200 and one of two terminals configuring electrode terminals of the middle heating element 300 may be designed as a common terminal 1130. In this case, the ceramic heater 100 having an independently controllable middle region according to an embodiment of the present disclosure may include a total of three electrode terminals 1110, 1120, and 1130.

Therefore, the ceramic heater 100 having an independently controllable middle region according to an embodiment of the present disclosure can independently control three regions of the heating surface of the ceramic heater by supplying power to two heating elements including three or four terminals. In other words, the ceramic heater 100 having an independently controllable middle region according to an embodiment of the present disclosure can variously design temperature distribution characteristics of three divided regions by using two power supply devices.

As a result, the ceramic heater 100 having an independently controllable middle region according to an embodiment of the present disclosure can control the temperature of three divided regions, and can reduce the number of heating element electrode terminals included in the ceramic plate 110 and the number of heating element rods included in the shaft 120, and thus also significantly reduce the risk of occurrence of a short circuit in a power supply process.

A ceramic heater having an independently controllable middle region according to the present disclosure is advantageous in that temperatures of three separate regions can be controlled by two power supply devices.

In addition, a ceramic heater having an independently controllable middle region according to the present disclosure is advantageous in that temperature distribution characteristics of three separate regions can be variously designed by two power supply devices.

In addition, a ceramic heater having an independently controllable middle region according to the present disclosure is advantageous the number of heating element electrode terminals included in a ceramic plate and the number of heating element rods included in a shaft can be reduced, thereby substantially reducing the risk of a short circuit in the power supply process.

Advantageous effects obtainable by a ceramic heater having an independently controllable middle region according to embodiments of the present disclosure are not limited to the above-mentioned advantageous effects, and other advantageous effects not mentioned herein will be clearly understood by a person skilled in the art to which the present disclosure pertains.

As described above, the present disclosure has been described by specified matters such as detailed components, and limited embodiments and drawings, but the description is merely provided to assist a more overall understanding of the present disclosure, and the present disclosure is not limited to the above embodiments and various modifications and changes can be made by those skilled in the art within a scope not departing from essential characteristics of the present disclosure. Accordingly, the spirit of the present disclosure should not be defined only by the described embodiments, and it should be appreciated that claims to be described below and the technical spirit, which is equivalent to the claims or equivalently modified, are included in the scope of right of the present disclosure.

1. A ceramic heater (100) having an independently controllable middle region, the ceramic heater comprising:
a center-edge heating element (200) provided at a position corresponding to a center region and an edge region of a heating surface of the ceramic heater; and
a middle heating element (300) provided at a position corresponding to a middle region surrounded by the center region and the edge region of the heating surface of the ceramic heater.

2. The ceramic heater (100) of claim 1, wherein the center-edge heating element (200) and the middle heating element (300) are electrically separated to be driven independently of each other.

3. The ceramic heater (100) of claim 1, wherein the center-edge heating element (200) and the middle heating element (300) are embedded in the ceramic heater.

4. The ceramic heater (100) of claim 1, wherein the center-edge heating element (200) and the middle heating element (300) are provided on the same plane.

5. The ceramic heater (100) of claim 1, wherein the center-edge heating element (200) and the middle heating element (300) are provided on different planes.

6. The ceramic heater (100) of claim 5, wherein at least one portion of the center-edge heating element (200) and the middle heating element (300) are disposed to overlap each other in a vertical direction.

7. The ceramic heater (100) of claim 1, wherein the center-edge heating element (200) includes a center heating element (210) and an edge heating element (220) that are provided on different planes.

8. The ceramic heater (100) of claim 1, wherein the center-edge heating element (200) and the middle heating element (300) are resistance heating elements.

9. The ceramic heater (100) of claim 8, wherein materials of the resistance heating elements are molybdenum (Mo).

10. The ceramic heater (100) of claim 1, wherein the middle heating element (300) is formed to have a ring shape.

11. The ceramic heater (100) of claim 1, wherein the center-edge heating element (200) comprises a center heating element disposed at a position corresponding to the center region, and an edge heating element disposed at a position corresponding to the edge region, and
the center heating element and the edge heating element are electrically connected to each other.

12. The ceramic heater (100) of claim 11, wherein the center heating element has a heating wire arrangement density or a heating wire thickness different from the edge heating element.

13. The ceramic heater (100) of claim 1, wherein one of electrode terminals of the center-edge heating element (200) and one of electrode terminals of the middle heating element (300) are configured as a common terminal.

14. The ceramic heater (100) of claim 1, wherein electrode terminals (910 and 920) of the center-edge heating element (200) are disposed on a plane where the center-edge heating element is provided, and
electrode terminals (930 and 940) of the middle heating element (300) are disposed on a plane where the middle heating element is provided.

15. The ceramic heater (100) of claim 14, wherein the electrode terminals (910 to 940) are disposed on an inside (1000) of a region corresponding to a region occupied by a shaft (120) on a surface opposite to the heating surface of the ceramic heater.
